(19) United States
(12) Patent Application Publication
(10) Pub. No.: US 2022/0269889 A1
(43) Pub. Date: Aug. 25, 2022

(54) VISUAL TAG CLASSIFICATION FOR AUGMENTED REALITY DISPLAY

(71) Applicant: GOOGLE LLC, Mountain View, CA (US)

(72) Inventors: Daniel Perry, Waterloo (CA); Rees Simmons, Kitchener (CA); Sushant Kulkarni, Kitchener (CA)

(21) Appl. No.: 17/229,499

(22) Filed: Apr. 13, 2021

Related U.S. Application Data
(60) Provisional application No. 63/009,548, filed on Apr. 14, 2020.

(51) Int. Cl. G06K 9/00; G06F 3/14; G06T 7/73; G06K 19/06; G06F 16/903; G02B 27/01

(52) U.S. Cl. CPC G06K 9/00671; G06F 3/14; G06T 7/73; G06K 19/06037; G06F 16/90335; G02B 27/0172; G06T 2207/30204; G06T 2200/24; G06K 2209/27; G02B 2027/0138; G02B 2027/014; G02B 2027/0178

(57) ABSTRACT

Techniques and systems associate augmented tag data with content data and provide for output of content associated with the content data. An augmented tag data is generated by associating anchor tag data with secondary tag data, the anchor tag data and the secondary tag data being associated with an image. Content data is associated with the augmented tag data and the augmented tag data is output in association with the content data. In another approach, a wearable heads up display (WHUD) or other system captures a live view (LV) image in a line of sight of a user of the WHUD, a match is detected between the augmented tag data and a combination of anchor tag data and secondary tag data associated with the LV image, and the content associated the content data is output via the WHUD.

### CROSS-REFRENCE TO RELATED APPLICATIONS

The present application claims priority to U.S. Provisional Patent Application No. 63/009,548, entitled “Augmented Reality Systems and Methods” and filed on Apr. 14, 2021, the entirety of which is incorporated by reference herein.

### BACKGROUND

Augmented Reality (AR) systems create AR experiences for users by combining a real-world environment with a virtual world. Some AR systems may overlay real-world scenes with AR visual elements to create the AR experience for the users.

### SUMMARY OF EMBODIMENTS

According to an implementation of the present specification there is provided a method, the method comprising: obtaining image data from a camera, the image data associated with an image; obtaining anchor tag data associated with an anchor tag associated with the image; obtaining secondary tag data associated with a secondary tag associated with the image; generating augmented tag data by associating the anchor tag data with the secondary tag data; associating content data with the augmented tag data, the content data associated with content; and outputting the augmented tag data in association with the content data, the augmented tag data to be used by a wearable heads-up display (WHUD) to trigger the WHUD to output the content based on the content data.

The obtaining the image data from the camera may comprise capturing the image using a corresponding camera of a corresponding WHUD; and obtaining the image data associated with the image from the corresponding WHUD.

The obtaining the anchor tag data may comprise determining the anchor tag associated with the image.

The determining the anchor tag may comprise: detecting a visual marker in the image; and designating the visual marker as the anchor tag.

The obtaining the image data may comprise obtaining a plurality of images of the anchor tag placed within a bounding box.

The obtaining the image data may further comprise: obtaining another plurality of images of the anchor tag added to an environment; and associating the anchor tag with features of the environment.

The obtaining the secondary tag data may comprise determining the secondary tag associated with the image.

The secondary tag may comprise one or more of: an environment tag, a sensor tag, a location tag, and a contextual tag.

The determining the secondary tag may comprise determining a static feature of an environment in the image, the static feature is associated with the secondary tag.

The obtaining the secondary tag data may comprise obtaining location data associated with a location associated with the image, the location being associated with the secondary tag of the image.

The obtaining the secondary tag data may comprise obtaining inertial measurement unit (IMU) data associated with the image.

The method may further comprise: determining a change in one or more of: the anchor tag, the secondary tag, and an environment corresponding to the image; and updating, based on the change, the augmented tag data.

The associating the content data with the augmented tag data may comprise receiving a selection of the content data, from a plurality of content data, for association with the augmented tag data.

The method may further comprise associating contextual data with the augmented tag data, the contextual data may define a trigger condition for the WHUD to output the content.

The contextual data is associated with one or more of: a time of day, previous interactions with the WHUD, and a length of time for which a live view is viewable via the WHUD.

The generating the augmented tag data may comprise determining a quality rating of the augmented tag data, the determining the quality rating may comprise comparing the augmented tag data with a plurality of tag data in a database to determine the quality rating of the augmented tag data.

The comparing the augmented tag data with the plurality of tag data may comprise determining a distinctiveness rating of an augmented tag associated with the augmented tag data.

The method may further comprise outputting the quality rating of the augmented tag data.

The method may further comprise in response to determining that the quality rating of the augmented tag data is below a threshold, adding additional data to the augmented tag data.

According to another implementation of the present specification there is provided a method, the method comprising: capturing a live view (LV) image of a live view in a line of sight of a user of a wearable heads-up display (WHUD), the LV image captured using a camera of the WHUD; obtaining anchor tag data based on LV image data associated with the LV image, the anchor tag data associated with an anchor tag associated with a first feature of the LV image; obtaining secondary tag data associated with a second feature of the LV image; obtaining augmented tag data comprising corresponding anchor tag data and corresponding secondary tag data, the corresponding anchor tag data associated with a corresponding anchor tag and the corresponding secondary tag data associated with a corresponding secondary tag associated with the corresponding anchor tag; comparing the anchor tag data and the secondary tag data with the corresponding anchor tag data of the augmented tag data and the corresponding secondary tag data of the augmented tag data respectively to detect a match between the augmented tag data and a combination of the anchor tag data and the secondary tag data; obtaining content data associated with the augmented tag data, the content data associated with content; and in response to detecting the match, outputting using the WHUD the content associated with the content data.

The obtaining the anchor tag data may comprise determining the anchor tag, the determining the anchor tag may comprise detecting a visual marker in the LV image, the visual marker may correspond to the first feature of the LV image.

The visual marker may comprise one or more of: an object, a text, a subject, a logo, a fiducial marker, and a code.

The obtaining the secondary tag data may comprise obtaining location data associated with a location associated with the image, the location corresponding to the second feature of the LV image.

The obtaining the secondary tag data may comprise determining a static feature of an environment in the LV image, the static feature may correspond to the second feature of the LV image.

The obtaining the secondary tag data may comprise obtaining one or more of: environment tag data, sensor tag data, location tag data, and contextual tag data.

The sensor tag data may comprise an inertial measurement unit (IMU) tag data.

The method may further comprise prior to the outputting, determining that a trigger condition for outputting of the content is met, the trigger condition being based on contextual data.

The contextual data is associated with one or more of: a time of day, previous interactions with the WHUD, and a length of time for which the live view is viewable via the WHUD.

According to yet another implementation of the present specification there is provided a system, the system comprising: a camera to capture an image of a scene; and a processing engine in communication with the camera, the processing engine to: obtain image data from the camera, the image data associated with the image; obtain anchor tag data associated with an anchor tag associated with the image; obtain secondary tag data associated with a secondary tag associated with the image; generate augmented tag data by associating the anchor tag data with the secondary tag data; associate content data with the augmented tag data, the content data associated with content; and output the augmented tag data in association with the content data, the augmented tag data to be used by a wearable heads-up display (WHUD) to trigger the WHUD to output the content based on the content data.

To obtain the anchor tag data, the processing engine is to determine the anchor tag associated with the image.

To determine the anchor tag, the processing engine is to: detect a visual marker in the image; and designate the visual marker as the anchor tag.

To obtain the image data, the processing engine is to obtain a plurality of images of the anchor tag placed within a bounding box.

To obtain the image data, the processing engine is further to: obtain further image data of a further plurality of images of the anchor tag added to an environment; and associate the anchor tag with features of the environment.

To obtain the secondary tag data, the processing engine is to determine the secondary tag associated with the image.

The secondary tag may comprise one or more of: an environment tag, a sensor tag, a location tag, and a contextual tag.

To determine the secondary tag, the processing engine is to determine a static feature of an environment in the image, the static feature is associated with the secondary tag of the image.

To obtain the secondary tag data, the processing engine is to obtain location data associated with a location associated with the image, the location associated with the secondary tag of the image.

To obtain the secondary tag data, the processing engine is to obtain inertial measurement unit (IMU) data associated with the image.

The processing engine is further to: determine a change in one or more of: the anchor tag, the secondary tag, and an environment corresponding to the image; and update, based on the change, the augmented tag data.

To associate the content data with the augmented tag data, the processing engine is to obtain a selection of the content data, from a plurality of content data, for association with the augmented tag data.

The processing engine is further to: associate contextual data with the augmented tag data, the contextual data may define a trigger condition for the WHUD to output the content.

The contextual data is associated with one or more of: a time of day, previous interactions with the WHUD, and a length of time for which a live view is viewable via the WHUD.

To generate the augmented tag data, the processing engine is to determine a quality rating of the augmented tag data, to determine the quality rating, the processing engine is to compare the augmented tag data with a plurality of tag data in a database to determine the quality rating of the augmented tag data.

To compare the augmented tag data with the plurality of tag data, the processing engine is to determine a distinctiveness rating of an augmented tag associated with the augmented tag data.

The processing engine is further to output the quality rating of the augmented tag data.

The processing engine is further to in response to a determination that the quality rating of the augmented tag data is below a threshold, add additional data to the augmented tag data.

According to yet another implementation of the present specification there is provided a wearable heads-up display (WHUD) comprising: a camera to capture scenes in a line of sight of a user wearing the WHUD; a light engine to generate a display light; a display optic to receive the display light from the light engine and direct the display light towards an eye of the user of the WHUD to form an image viewable by the user; and a controller in communication with the camera and the light engine, the controller to: control the camera to capture a live view (LV) image of a live view in the line of sight of the user of the WHUD; obtain anchor tag data based on LV image data associated with the LV image, the anchor tag data associated with an anchor tag associated with a first feature of the LV image; obtain secondary tag data associated with a second feature of the LV image; obtain augmented tag data comprising corresponding anchor tag data and corresponding secondary tag data, the corresponding anchor tag data associated with a corresponding anchor tag and the corresponding secondary tag data associated with a corresponding secondary tag associated with the corresponding anchor tag; compare the anchor tag data and the secondary tag data with the corresponding anchor tag data of the augmented tag data and the corresponding secondary tag data of the augmented tag data respectively to detect a match between the augmented tag data and a combination of the anchor tag data and the secondary tag data; obtain content data associated with the augmented tag data, the content data associated with content; and in response to detecting the match, output using the WHUD the content associated with the content data.

To obtain the anchor tag data, the controller is to determine the anchor tag, to determine the anchor tag, the controller is to detect a visual marker in the LV image, the visual marker may correspond to the first feature of the LV image.

The visual marker may comprise one or more of: an object, a text, a subject, a logo, a fiducial marker, and a code.

To obtain the secondary tag data, the controller is to: obtain location data associated with a location associated with the image, the location may correspond to the second feature of the LV image.

To obtain the secondary tag data, the controller is to determine a static feature of an environment in the LV image, the static feature may correspond to the second feature of the LV image.

To obtain the secondary tag data, the controller is to obtain one or more of: environment tag data, sensor tag data, location tag data, and contextual tag data.

The sensor tag data may comprise an inertial measurement unit (IMU) tag data.

The controller is further to prior to the outputting, determine that a trigger condition for outputting of the content is met, the trigger condition being based on contextual data.

The contextual data is associated with one or more of: a time of day, previous interactions with the WHUD, and a length of time for which the live view is viewable via the WHUD.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the shapes of the elements as drawn are not necessarily intended to convey any information regarding the actual shape of the particular elements, and have been solely selected for ease of recognition in the drawings.

FIG. 1 shows a flowchart of an example method of associating augmented tag data with content data in accordance with some embodiments of the present disclosure.

FIG. 2 shows a flowchart of an example method of outputting content in accordance with some embodiments of the present disclosure.

FIG. 3 shows a schematic representation of an example system which is used to associate augmented tag data with content data in accordance with some embodiments of the present disclosure.

FIG. 4 shows a schematic representation of an example system which is used to display content in accordance with some embodiments of the present disclosure.

FIG. 5 shows a partial-cutaway perspective view of an example wearable heads-up display in accordance with some embodiments of the present disclosure.

FIGS. 6A and 6B show example illustrations of methods disclosed herein in accordance with some embodiments of the present disclosure.

### DETAILED DESCRIPTION

In the following description, certain specific details are set forth in order to provide a thorough understanding of various disclosed implementations. However, one skilled in the relevant art will recognize that implementations is practiced without one or more of these specific details, or with other methods, components, materials, and the like. In other instances, well-known structures associated with light sources have not been shown or described in detail to avoid unnecessarily obscuring descriptions of the implementations. Unless the context requires otherwise, throughout the specification and claims which follow, the word “comprise” and variations thereof, such as, “comprises” and “comprising” are to be construed in an open, inclusive sense, that is as “including, but not limited to.” As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise. The headings and Abstract of the Disclosure provided herein are for convenience only and do not interpret the scope or meaning of the implementations. Throughout this specification and the appended claims, the term “carries” and variants such as “carried by” are generally used to refer to a physical coupling between two objects. The physical coupling is direct physical coupling (i.e., with direct physical contact between the two objects) or indirect physical coupling that is mediated by one or more additional objects. Thus, the term carries and variants such as “carried by” are meant to generally encompass all manner of direct and indirect physical coupling, including without limitation: carried on, carried within, physically coupled to, secured to, and/or supported by, with or without any number of intermediary physical objects therebetween.

Visual tags in a physical environment are used for displaying relevant content on a heads-up display (HUD). Some examples of such visual tags include (Quick Response) QR codes, augmented reality (AR) markers, and augmented images. The size and complexity of image(s) needed for detecting such visual tags with high accuracy may pose technical challenging in implementing AR systems. For example, augmented images for ARCore® (software development kit for building AR applications) need images that are large enough and at a close enough distance to capture at least 300×300 pixels with minimum repetition of features in the image. The difficulty of meeting these minimum image quality requirements may lead to a lower AR accuracy or quality in many applications.

The systems and methods disclosed herein use features of objects detected in an environment, their association with each other, and additional metadata such as geolocation, to improve classification of visual tags. Based on the classification, personalized content is associated with the visual tags and is output using a wearable heads-up display (WHUD). By using the combined representation of image(s), features of objects in the environment, and other available metadata such as location, the systems and methods disclosed herein allow for classification of the visual tags (for example visual tags which are at greater distances) with improved accuracy. An increase in the accuracy of classification of visual tags, in turn, may improve the quality or accuracy of AR functions or applications that rely on those visual tags.

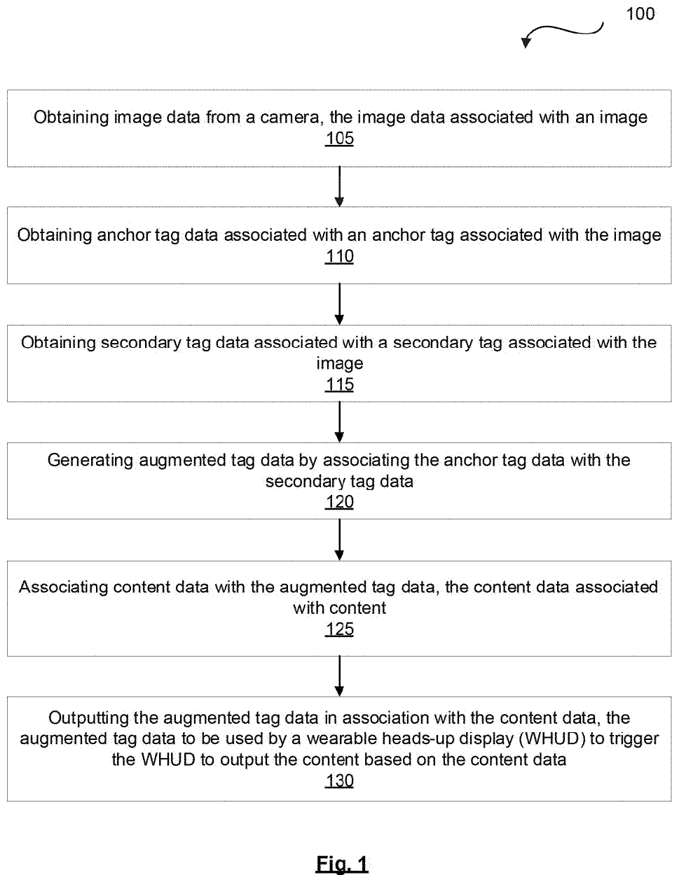

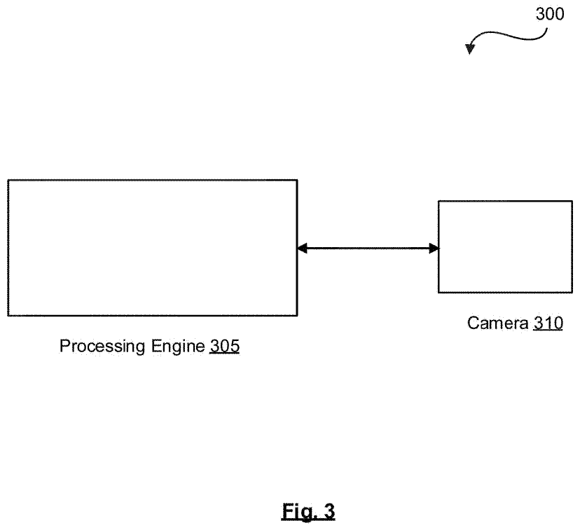

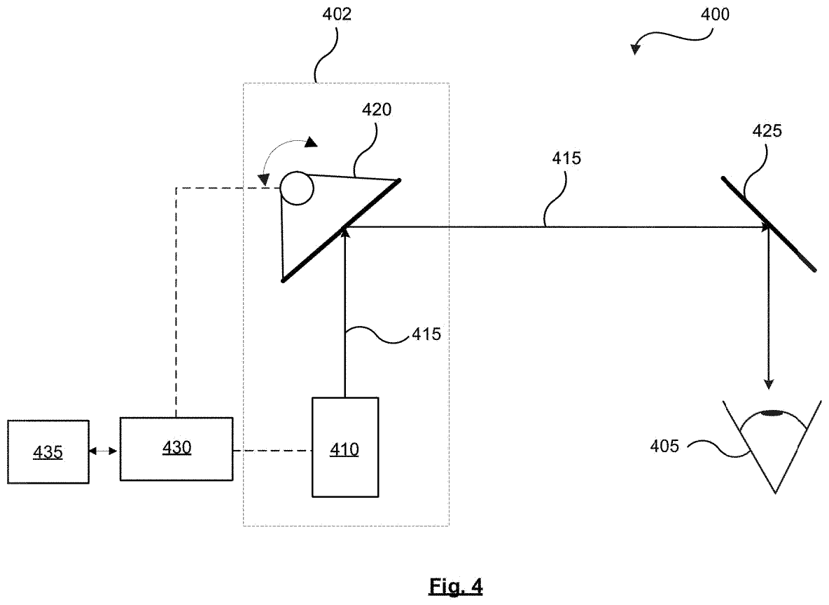

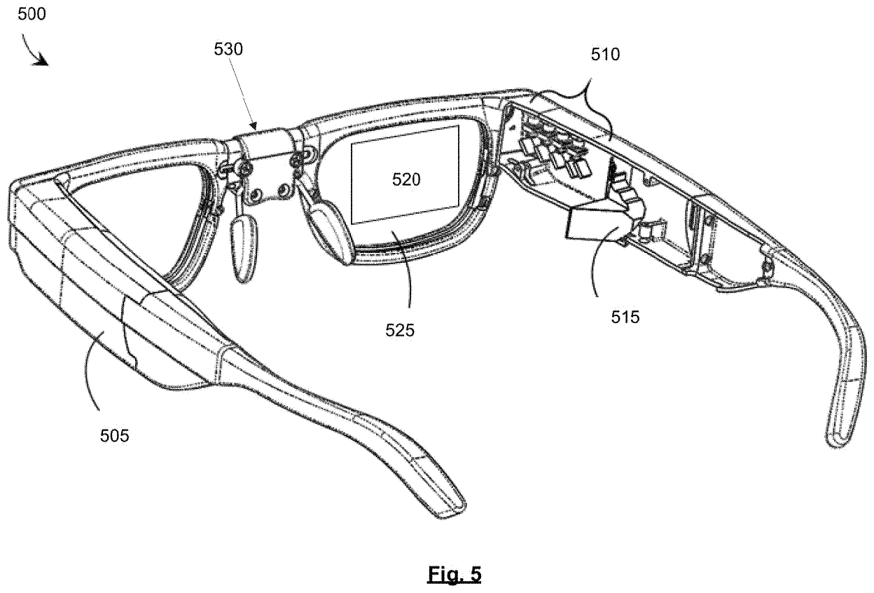

FIG. 1 shows a flowchart of an example method 100 of associating content with augmented tags. The method 100 is performed using an example system 300 (FIG. 3), by an example system 400 (FIG. 4), or by a WHUD 500 (FIG. 5), which may incorporate the system 300 or system 400. In some examples, the method 100 is performed by the system 300. In such examples, the processing engine 305 may perform or control performance of operations described in method 100. In some examples, the method 100 is performed by the system 400. In such examples, the controller 430 may perform or control performance of operations described in method 100. In some examples, the system 300 is implemented as a part of or incorporated into the system 400. In some examples, the system 300 or system 400 is implemented as a part of or incorporated into the WHUD 500.

Turning now to method 100, at block 105 image data associated with an image is obtained from a camera. In some examples, the image data is obtained from a camera of a WHUD, such as WHUD 500. For example, the camera of the WHUD captures the image, and image data associated with the captured image is obtained from the WHUD. Additionally, or alternatively, video is captured using the camera, from which image(s) or image data is obtained. In some examples, the environment may include a physical environment (e.g., a real-world location) that is surrounding or in the line of sight of the camera. In some examples, multiple images are captured, each image being captured from a different viewing perspective. In some examples, the images are captured using a camera of an AR apparatus, which controls the image capturing process. For example, the AR apparatus may instruct a wearer to walk around the physical environment and capture the images from different perspectives. In some examples, the wearer is instructed to capture a particular physical object or feature of the environment, which is used in relation to generation of the augmented tag data. In some examples, image data associated with the multiple captured images is obtained.

At block 110, anchor tag data associated with an anchor tag associated with the image is obtained. In some examples, the anchor tag associated with the image is determined. In some examples, the anchor tag associated with the image is set by default, for example, by an administrator or a user of the WHUD, and stored in a database. The database may include a collection of tags specific to a location (e.g., a real-world location). The tags are created by, for example, organizations or third-party developers. In some examples, the tags in the database are anchor tags which have secondary tags associated with them. In some examples, the anchor tags in the database may have additional metadata, such as geolocation metadata, associated with them along with the secondary tags.

In some examples, a visual marker in the image is detected and then designated as the anchor tag associated with the image. For example, the visual marker may comprise an object, a text, a subject, a logo, a fiducial marker, or a code (e.g., QR code), or the like. It is contemplated that any visual feature in the image that is distinctive and is particular to the environment (e.g., real world location) captured in the image is designated as the anchor tag.

In some examples, where the anchor tag is not set (for example, the anchor tag is not found in a database that stores information associated with the tags), an image or a plurality of images of an anchor tag (e.g., a visual marker) placed within a bounding box are obtained. In some examples, the images are captured (for example, by a user of the AR apparatus) using the same camera as the camera from which the image data is obtained. Further, another image or plurality of images of the anchor tag added to the environment (e.g., environment captured in the image) are obtained, and the anchor tag is then associated with features of the environment. For example, the images of the anchor tag may include images of the anchor tag placed at a particular position in the environment (e.g., placed at a desired location by a user). Such images may establish a relationship between the anchor tag and additional features of the environment. The relationship between the anchor tag and the additional features of the environment is captured and stored as metadata along with the anchor tag in the database, for example, to create a mapping between the anchor tag and the features of the environment.

At block 115, secondary tag data associated with a secondary tag associated with the image is obtained. In some examples, the secondary tag associated with the image is determined, and the secondary tag data associated with the determined secondary tag is obtained. In some examples, the secondary tag may comprise one or more of an environment tag, a sensor tag, a location tag, and a contextual tag.

In some examples, the environment tag may comprise a static feature of an environment in the image. The static feature is associated with the secondary tag. For example, the static feature of the environment in the image is determined and designated as the secondary tag. The static features may include objects of the physical environment that are static in the image(s). The static features may include objects that may have some degree of change associated with them but their position in the given environment (scene) is fixed. For example, a door opens and closes but it is considered as the static feature since its position in the environment (scene) is fixed. Similarly, a tree grows but its position in the environment (scene) is fixed, so it is considered as the static feature. Some other examples of the static features include, but not limited to, buildings, landmarks, lamp posts, desks, clocks on the walls, and the like.

In some examples, the objects in the image are identified, and respective bounding boxes for the objects are determined. Based on the respective bounding boxes, the objects are classified as static features or transient features. The transient features may include objects that appear to be moving in the image(s), which may include, but not limited to, people, vehicles, and the like. So, the static objects may remain static in the respective bounding boxes and thus is determined as the static features, and the non-static objects may move out of the respective bounding boxes, and thus is determined as the transient features.

In some examples, to identify a static feature of the environment in the image, a neural network-based processing is employed. For example, a region proposal classification network such as a region convolutional neural network (RCNN) that identifies objects in the image, classifies the objects, and determines respective bounding boxes for the objects is employed. The respective bounding boxes for the objects is defined as permanent object bounds or transient object bounds. One such example neural network based regional proposal classification network that is used to identify the static feature is “You Only Look Once” (YOLO) algorithm. The YOLO algorithm may include a convolutional neural network (CNN) for doing object detection in real-time. The YOLO algorithm applies a single neural network to the full image, and then divides the image into regions and predicts bounding boxes and probabilities for each region.

In some examples, a set of features corresponding to the objects in the image is identified. Further, a descriptor for each feature of the set of features is identified, and a 3D geometric position for each feature is determined. Furthermore, the static feature is identified based on the descriptors and the 3D geometric positions.

In some examples, the set of features is generated by implementing feature detection algorithms, such as, but not limited to, the Harris Corner Detection algorithm, the Scale-Invariant feature transform (SIFT) algorithm, and the like. Furthermore, a descriptor for each feature, is generated and stored as being associated with the feature. In some examples, the descriptor is generated for an image patch immediately surrounding the location of the feature within the image. In some examples, a feature matching (e.g., temporal feature matching) is performed to identify a set of common features that appear in the multiple images of the scene. In such examples, a simultaneous localization and mapping (SLAM) algorithm is employed to identify the set of common features, and thus the static feature. Where 3D depth data associated with the image is obtained, the algorithms, such as but not limited to a Point-Cloud registration algorithm, are employed to do feature mapping, and thereby identify the static feature in the images based on the 3D depth data.

The sensor tag data may include sensor data associated with the image. The sensor data my be designated as the secondary tag. In some examples, an inertial measurement unit (IMU) data associated with the image is determined. The IMU data associated with the image is obtained from an image capturing device, for example from an IMU sensor of the camera. In some examples, when the camera has a capability of three-dimensional (3D) depth sensing, 3D depth data associated with the image is determined or obtained from the camera and may also be designated as the environment tag.

The location tag may include location data that may correspond to a location associated with the image. For example, the location associated with the image is determined, and location data associated with the location is designated as the secondary tag. In some examples, the location associated with the image is a location from where the image is captured. In some examples, the location of image capturing is obtained from one or more of a geolocation service, a wireless network access point, such as a Wi-Fi® access point nearby to the camera, and the like. The location of the camera may have a resolution of several meters. In some examples, the location associated with the image is a location of an environment (e.g., location of a particular scene or a location of a particular feature of the environment) captured in the image. The contextual tag may include contextual content that is distinctive. For example, the contextual data that may define a trigger condition for the WHUD to output the content associated with the augmented tag data (that comprises secondary tag data) is designated as the secondary tag. The trigger condition may include a time of day, previous interactions with the WHUD, and a length of time for which a live view is viewable via the WHUD, or the like.

At block 120, augmented tag data is generated by associating the anchor tag data with the secondary tag data. In some examples, the augmented tag is a combination of the anchor tag and the secondary tag associated with the image. The augmented tag data is a combination of the anchor tag data and the secondary tag data. In some examples, a quality rating of the augmented tag data is determined by comparing the augmented tag data with a plurality of tag data in a database. The augmented tag data is compared with the plurality of tag data to determine a distinctiveness rating of the augmented tag associated with the augmented tag data. The distinctiveness rating is indicative of whether feature(s) of the augmented tag are sufficiently unique and robust enough for accurate classification. For example, the combination of the anchor tag and the secondary tag of the augmented tag is compared with a pool of tags or tag combinations in the database to check for uniqueness and quality of the augmented tag.

In some examples, a quality rating system is implemented, and it is determined if the quality rating of the augmented tag or augmented tag data meets a threshold. The threshold is a tag quality threshold. If the quality rating of the augmented tag or augmented tag data is below the threshold, additional data is added to the augmented tag data. For example, the user is prompted to add additional tags, e.g., location tag data, sensor tag data, contextual tag data, or the like to the augmented tag data. The additional tag data may not be initially present in the augmented tag data. In other words, additional tags for the image, which may not be initially present in the augmented tag, is added to the augmented tag. The addition of the additional tag data to the augmented tag data may make augmented tag more distinctive (relative to other tags), and may improve distinctiveness rating of the augmented tag, and thus improve quality of the augmented tag data.

In some examples, if the quality rating of the augmented tag or augmented tag data is below the threshold, the user is prompted to recapture image(s) of the anchor tag or features, such as but not limited to environmental features of a scene, captured in the earlier image. Otherwise, the quality rating of the augmented tag data is output. For example, the quality rating of the augmented tag data is provided to the WHUD.

To generate the augmented tag data, the interaction with the registered augmented tags (e.g., augmented tag available in the database) could be completely automated or initiated entirely by the user. Upon initiation, the image and algorithms such as, but not limited to, a one-shot learning neural network or other optimized classification algorithm are used to match the image to the features (such as anchor tag, secondary tag, or the like) of the augmented image in the database. Based on the matching, the augmented tag is either added to the database or updated.

In some examples, a change in one or more of the anchor tags, the secondary tag, and the environment corresponding to the image is determined. Based on the change, the augmented tag data (e.g., augmented tag) is determined. For example, if an anchor object (anchor tag) moves or objects in the scene (of the image) change, such as, a picture in the scene moved, or a clock comes off a wall, the augmented tag data (augmented tag) is updated either automatically or as the user interacts with the augmented tag.

At block 125, the content data is associated with the augmented tag data. The content data is associated with the content which is output (e.g., displayed) by the WHUD. In some examples, a selection of the content data, from a plurality of content data, for association with the augmented tag data, is received, and then the selected content data is associated with the augmented tag data. In other words, content is selected from a plurality of content, for example, by the user of the WHUD. Then, content data associated with the selected content is associated with the augmented tag. In some examples, the content data is associated with the augmented tag data, or the content is associated with the augmented tag, after obtaining permissions from a user, for example, the user of the WHUD that is to output the content. In some examples, the content to be associated with the augmented tag is suggested or defined by the user. For example, the user may define for the WHUD to output (e.g., display) particular content in response to detecting particular anchor tag and secondary tag(s) in the live view of the user. To illustrate, the content data can be associated with audio content, video content, or the like. The content is personalized. For example, the content may comprise private content, such as text messages, images, emails, personal communications, or the like that are private for the user of the WHUD. In some examples, the content is publicly available content. In some examples, the private content associated with the augmented tags is encrypted, e.g., end-to-end encrypted.

The content data can instead be associated with the augmented tag data, or content associated with the augmented tag, and is determined based on either the anchor tag of the augmented tag, or the secondary tag of the augmented tag, or both. For example, if the anchor tag includes a visual marker, such as a logo of a company, the content is an advertisement associated with the company. In another example, if the anchor tag includes visual information about an event (e.g., concert), the content may include ticketing information for the event. In another example, if the secondary tag includes a location information of a particular location, the content may include content that is relevant to that location. In another example, if the anchor tag includes a map, the content is determined based on information in the map. It is to be noted that these are just few examples of the relationship between the augmented tag and the content associated with the augmented tag. It is contemplated that content is any content, which may or may not be determined based on the augmented tag, the anchor tag, or the secondary tag.

At block 130, the augmented tag data is output in association with the content data. The augmented tag data is to be used by the WHUD to trigger the WHUD to output the content based on the content data. In some examples, contextual data is associated with the augmented tag data. The contextual data may define a trigger condition for the WHUD to output the content. The trigger condition may include a time of the day, previous interactions with the WHUD, a length of time for which a live view is viewable via the WHUD, and the like. In some examples, the trigger condition is defined by the user of the WHUD.

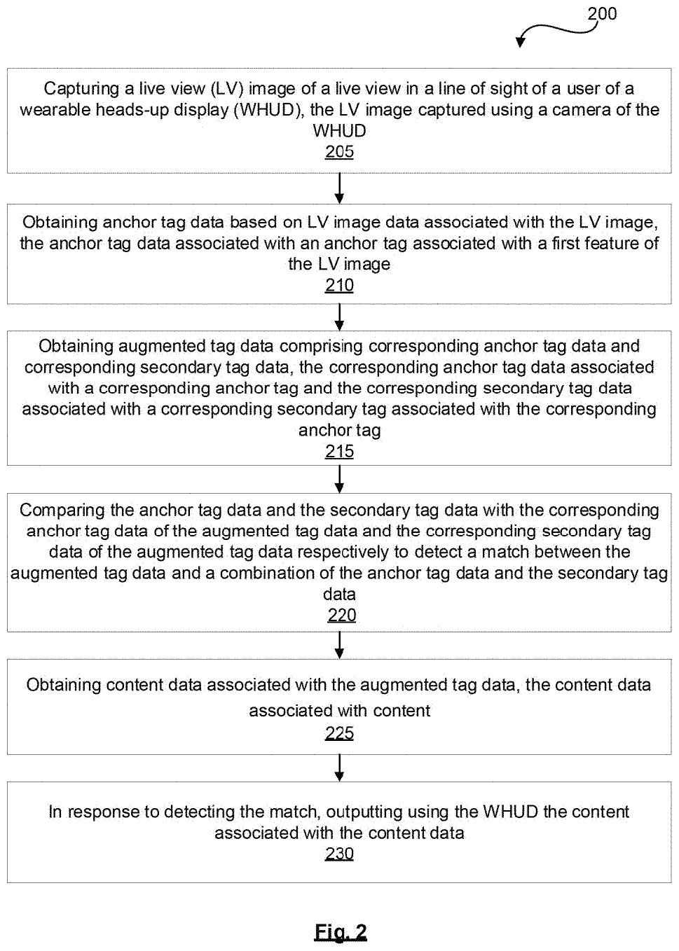

In some examples, the augmented tag data in association with the content data is provided to the WHUD for the WHUD to display the content associated with the content data in response to determining that the augmented tag data is associated with a live view (LV) image associated with the WHUD and in response to detecting the trigger defined by the contextual data. The LV image may include image of a live view in a line of sight of the user of the WHUD. The displaying of such content by the WHUD is explained in detail in relation to FIG. 2. The augmented tag data in association with the content data can be provided to the WHUD directly. Moreover, in some examples, the augmented tag data in association with the content data is provided to the WHUD indirectly. For example, the augmented tag data in association with the content data is provided to another entity (e.g., server), which may then provide the augmented tag data in association with the content data to the WHUD. In some examples, the augmented tag data in association with the content data is made accessible on a repository from where it is retrieved for use by the WHUD (e.g., by the WHUD itself). Where the method 100 is performed at the WHUD itself, the WHUD may use the association between the augmented tag data and the content data to output content, for example, to augment the live view in the line of the sight of the user of the WHUD.

FIG. 2 shows a flowchart of an example method 200 of outputting content by a system, such as a WHUD, and the like. In some examples, the example method 200 is performed by system 400 or WHUD 500 (which may incorporate system 400). The system, in some embodiments, comprises a camera, a light engine, a display optic, and a controller. The outputting of the content is controlled by a controller, such as controller 430 of system 400.

At block 205, a live view (LV) image of a live view in a line of sight of a user of a wearable heads-up display (WHUD), is captured. The LV image is captured using a camera of the WHUD. For example, the LV image is captured by camera 530 of WHUD 500. At block 210, anchor tag data based on LV image data associated with the LV image is obtained. The anchor tag data is associated with an anchor tag associated with a first feature of the LV image. In some examples, the anchor tag data is obtained by determining the anchor tag. The anchor tag is determined by detecting a visual marker in the LV image. The visual marker may correspond to the first feature of the LV image. The visual marker can be, for example, the first feature of the LV image. The visual marker may comprise an object, a text, a subject, a logo, a fiducial marker, a code, or the like, in the LV image.

At block 215, the secondary tag data associated with the second feature of the LV image is obtained. As described above, in some examples, the secondary tag data may comprise environment tag data, sensor tag data, location tag data, contextual tag data, and the like. For example, the environment tag data is obtained as the secondary tag data. In some examples, the environment tag data is determined by determining a static feature of an environment in the LV image. The static feature may correspond to the second feature of the LV image.

As described above, the static feature may include objects of the environment (e.g., physical environment) that are static in the image(s), which may include, but not limited to, buildings, landmarks, trees, lamp posts, doors, desks, clocks on the walls, and the like.

Some of the example methods to determine the static feature, which are described above are used by the WHUD to determine the static feature in the LV image. For example, the objects in the LV image are identified, and respective bounding boxes for the objects is determined. Based on the respective bounding boxes, the objects are classified as static features or transient features. The transient features may include objects that appear to be moving in the image(s), which may include, but not limited to, people, vehicles, and the like. In some examples, the transient features may include entities that may not be moving in the images, but which entities is capable of moving. For example, a parked care in the image is identified as a transient feature. So, the static objects may remain static in the respective bounding boxes and thus is determined as the static features, and the non-static objects may move out of the respective bounding boxes, and thus is determined as the transient features.

To identify a static feature of the environment in the LV image, a neural network-based processing can be employed. For example, a region proposal classification network such as a region classification neural network (RCNN) that identifies objects in the LV image, classifies the objects, and determines respective bounding boxes for the objects is employed. The respective bounding boxes for the objects is defined as permanent object bounds or transient object bounds. One such example neural network based regional proposal classification network that is used to identify the static feature is “You Only Look Once” (YOLO) algorithm. The YOLO algorithm may include a convolutional neural network (CNN) for doing object detection in real-time. The YOLO algorithm applies a single neural network to analyze the full image, and then divides the LV image into regions and predicts bounding boxes and probabilities for each region.

In some examples, a set of features corresponding to the objects in the LV image is identified. Further, a descriptor for each feature of the set of features is identified, and a 3D geometric position for each feature is determined. Furthermore, the static feature is identified based on the descriptors and the 3D geometric positions. The set of features can be generated by implementing feature detection algorithms, such as, but not limited to, the Harris Corner Detection algorithm, the Scale-Invariant feature transform (SIFT) algorithm, and the like. Furthermore, a descriptor for each feature, is generated and stored as being associated with the feature. In some examples, the descriptor is generated for an image patch immediately surrounding the location of the feature within the LV image. A feature matching (e.g., temporal feature matching) is performed to identify a set of common features that appear in the multiple images of the LV scene. In such examples, a simultaneous localization and mapping (SLAM) algorithm is employed to identify the set of common features, and thus the static feature. Where the 3D depth data associated with the LV image is available, the algorithms, such as but not limited to a Point-Cloud registration algorithm is employed to do feature mapping, and thereby identify the static feature in the LV image based on the 3D depth data.

The secondary tag data may include sensor tag data, which is associated with the image. The sensor tag data is an inertial measurement unit (IMU) data. The IMU data associated with the image is obtained from an IMU sensor of the WHUD. In some examples, the sensor tag data is 3D depth data. For example, when the camera of the WHUD has a capability of three-dimensional (3D) depth sensing, 3D depth data associated with the LV image is determined or obtained from the camera.

The location tag data may be obtained as the secondary tag data. The location tag data may include location data that may correspond to a location associated with the LV image. For example, a location associated with the LV image is determined, and location data associated with the location is obtained as the secondary tag data. In some examples, the location associated with the image is a location of the WHUD at the time of LV image capturing. In some examples, the location of WHUD is obtained from one or more of a geolocation service, a wireless network access point, such as a Wi-Fi® access point nearby to the WHUD, and the like. The location of the WHUD may have a resolution of several meters. In some examples, the location associated with the LV image is a location of a scene captured in the LV image.

The contextual tag data may be obtained as the secondary tag data. The contextual tag data may include contextual content that is distinctive. For example, the contextual data that may define a trigger condition for the WHUD to output the content associated with the augmented tag data may comprise secondary tag data. The trigger condition may include a time of day, previous interactions with the WHUD, and a length of time for which a live view is viewable via the WHUD, or the like.

At block 215, augmented tag data comprising corresponding anchor tag data and corresponding secondary tag data is obtained. The corresponding anchor tag data is associated with a corresponding anchor tag and the corresponding secondary tag data is associated with a corresponding secondary tag associated with the corresponding anchor tag. In some examples, the augmented tag data is associated with previously captured images of the same environment (e.g., same real-world location, same scene, or the like) that is being captured in the LV image.

As described above in relation to method 100, the augmented tag data may have been generated previously by associating the corresponding anchor tag and the corresponding secondary tag associated with the previously captured images. The augmented tag data may have been stored (in association with the content data) either locally at the WHUD or at a remote location (e.g., in a cloud hosted database or in another device accessible to the WHUD) from where the augmented tag data is retrieved or otherwise obtained by the WHUD. For example, the augmented tag data in association with the content data is made accessible on the repository (as described previously in relation to method 100) from where the augmented tag data is retrieved for use by the WHUD.

At block 220, the anchor tag data and the secondary tag data, associated with the LV image, are compared with the corresponding anchor tag data of the augmented tag data and the corresponding secondary tag data of the augmented tag data respectively to detect a match between the augmented tag data and a combination of the anchor tag data and the secondary tag data. In some examples, it is determined whether the anchor tag data associated with the LV image matches with the corresponding anchor tag data of the augmented tag data, and whether the secondary tag data matches with the corresponding secondary tag data of the augmented tag data. In response to determining that the anchor tag data and the secondary tag data associated with the LV image match with the corresponding anchor tag data and the corresponding secondary tag data of the augmented tag data respectively, the matching of the augmented tag data with the combination of the anchor tag data and the secondary tag data is detected.

In other words, it is determined whether the anchor tag associated with the LV image matches with the corresponding anchor tag of the augmented tag, and whether the secondary tag matches with the corresponding secondary tag of the augmented tag. In response to determining that the anchor tag and secondary tag associated with the LV image matches with the corresponding anchor tag and the corresponding secondary tag of the augmented tag respectively, the matching of the augmented tag data with the combination of the anchor tag data and the secondary tag data is detected.

At block 225, content data associated with the augmented tag data is obtained. As described previously in relation to method 100, the augmented tag data in association with the content data is stored in a repository. In some examples, the content data is obtained from the repository that is accessible to the WHUD. The content data is associated with the content. In some examples, the content is audio content, displayable content such as the image content, video content, or the like. In some examples, the content is interactive content. In some examples, the content is personalized. For example, the content may a private content, such as text messages, images, emails, personal communications, or the like that are private for the user of the WHUD. In some examples, the content is publicly available content.

At block 230, in response to detecting the match, the content associated with the content data is output using the WHUD. In some examples, the content is displayable content. In such examples, the content is displayed by the WHUD, for example, to augment a live view of the user of the WHUD. In some examples, the content is audio content which is output, for example, by a speaker of the WHUD. In some examples, prior to the outputting, it is determined that a trigger condition for outputting of the content is met. The trigger condition can be based on contextual data. The example trigger condition may comprise a time of day, previous interactions with the WHUD, and a length of time for which the live view is viewable via the WHUD. For example, after detecting the match between the augmented tag data and the combination of the anchor tag data and the secondary tag data, the WHUD may determine if the trigger condition for outputting the content is met. If the trigger condition is met, then the WHUD may output the content. If the trigger condition is not met, the WHUD may not output the content and may wait for the trigger condition to be met.

Methods 100, 200 illustrated above provide a few examples of augmented tag (augmented tag data) and secondary tags (secondary tag data). It is contemplated that in some examples the example anchor tag(s) described above is used as the secondary tag(s), and the example secondary tags described above is used as the anchor tag in relation to the methods 100, 200. It is further contemplated that the augmented tag is made up of any number of anchor tags and any number of secondary tags.

Turning now to FIG. 3, an example system 300 is shown which is used to perform, for example, the method 100 of FIG. 1 in accordance with some embodiments. System 300 comprises a processing engine 305 in communication with a camera 310. Processing engine 305 may control the camera 310 to capture an image. In some examples, the image to be captured is a still image, a video, and the like. Processing engines such as the processing engine 305 described herein may comprise at least one processor in communication with at least one non-transitory processor-readable medium. The processor-readable medium may have instructions stored thereon which when executed cause the processor to control the camera as described in relation to the methods and systems described herein. The processor-readable medium may also store any data that is processed or stored in relation to the methods and systems described herein. Moreover, in some examples, the processing engines is free-standing components, while in other examples the processing engines may comprise functional modules incorporated into other components of their respective systems. Furthermore, in some examples the processing engines or their functionality is implemented in other ways, including: via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors (e.g., microprocessors, central processing units, graphical processing units), as firmware, and the like, or as a combination thereof. The processing engines or some or all of their functionality is implemented on a cloud-based processing system; as an app operable on devices such as a smartphone, tablet, computer, or AR/VR (augmented reality/virtual reality) headset, or the like; as a software plug-in to an animation software package operable on a phone, tablet, computer, or AR/VR headset, or the like; or as an API available to application developers.

Turning now to FIG. 4, a schematic representation is shown of an example system 400 which is used to perform method 200 of FIG. 2, for example, to output content. System 400 is used to form or project an image viewable by an eye 405 of a viewer. System 400 may also be referred to or described as an image projection device, a display device, a display system, or a display. The viewer may also be described as a user of system 400. System 400 may comprise a light engine 402 to generate a beam of output light 415. In some examples, light engine 402 may comprise a light source 410 to generate output light 415. Light source 410 may comprise at least one laser, at least one light emitting diode, and the like. Light engine 402 may also comprise a spatial modulator 420 to receive output light 415 from light source 410. In some examples, spatial modulator 420 may comprise a movable reflector, a micro-electro-mechanical system (MEMS), a digital micromirror device (DMD), and the like. While FIG. 4 shows light engine 402 as comprising spatial modulator 420, it is contemplated that in some examples light engine 402 need not comprise spatial modulator 420 or light source 410. In some examples, light engine 402 may comprise a micro-display, or other light sources suitable for forming an image. Furthermore, system 400 may comprise a display optic 425 to receive output light 415 from light engine 402 and direct the output light towards eye 405 of a viewer to form an image viewable by the user. Moreover, in some examples system 400 is a part of or incorporated into a wearable heads-up display (WHUD). Such a heads-up display may have different designs or form factors, such as the form factor of eyeglasses, as is described in greater detail in relation to FIG. 5. In examples where system 400 is in the form factor of glasses, display optic 425 is on or in a lens of the glasses.

In addition, system 400 comprises a controller 430 in communication with the light engine 402, and a camera 435. Controller 430 may control the light engine 402 to project an image. Controller 430 may control camera 435 to capture images of a scene in a line of sight of the viewer. In some examples, system 400 is used to form or project an image. Moreover, in some examples, the image to be projected is a still image, a moving image or video, an interactive image, a graphical user interface, and the like. The controllers described herein, such as controller 430, may comprise at least one processor in communication with at least one non-transitory processor-readable medium. The processor-readable medium may have instructions stored thereon which when executed cause the processors to control the light source and the spatial modulator as described in relation to the methods and systems described herein. Moreover, in some examples the controllers are free-standing components, while in other examples the controllers may comprise functional modules incorporated into other components of their respective systems. Furthermore, in some examples the controllers or their functionality is implemented in other ways, including: via Application Specific Integrated Circuits (ASICs), in standard integrated circuits, as one or more computer programs executed by one or more computers (e.g., as one or more programs running on one or more computer systems), as one or more programs executed by on one or more controllers (e.g., microcontrollers), as one or more programs executed by one or more processors (e.g., microprocessors, central processing units, graphical processing units), as firmware, and the like, or as a combination thereof.

Turning now to FIG. 5, a partial-cutaway perspective view of an example wearable heads-up display (WHUD) 500 is shown. WHUD 500 includes a support structure 505 that in use is worn on the head of a user and has the general form factor and appearance of an eyeglasses (e.g., sunglasses) frame. Eyeglasses or sunglasses may also be generically referred to as “glasses”. Support structure 505 may carry components of a system to output content (e.g., augmented reality content), such as system 400, and/or components to generate and output augmented tag data in association with content data, such as system 300. For example, the light source module is received in a space 510 in a side arm of support structure 505. In other examples, one or more of the image projection and output light adjustment system components or systems described herein is received in or carried by support structure 505. The spatial modulator of the systems described herein is received in or be part of component 515 of support structure 505. The spatial modulator in turn may direct the output light onto a display optic 520 carried by a lens 525 of support structure 505. In some examples, display optic 520 is similar in structure or function to display optic 425. Moreover, in some examples display optic 520 may comprise light guide comprising an optical incoupler and an optical outcoupler. WHUD also includes a camera 530, which is carried by support structure 505. Though FIG. 5 shows the camera 530 to be present on a front side of the support structure to capture views as seen by the wearer, it is contemplated that in some examples the camera 530 may also be present on any other location on the support structure (such as in the side arm of the support structure 505).

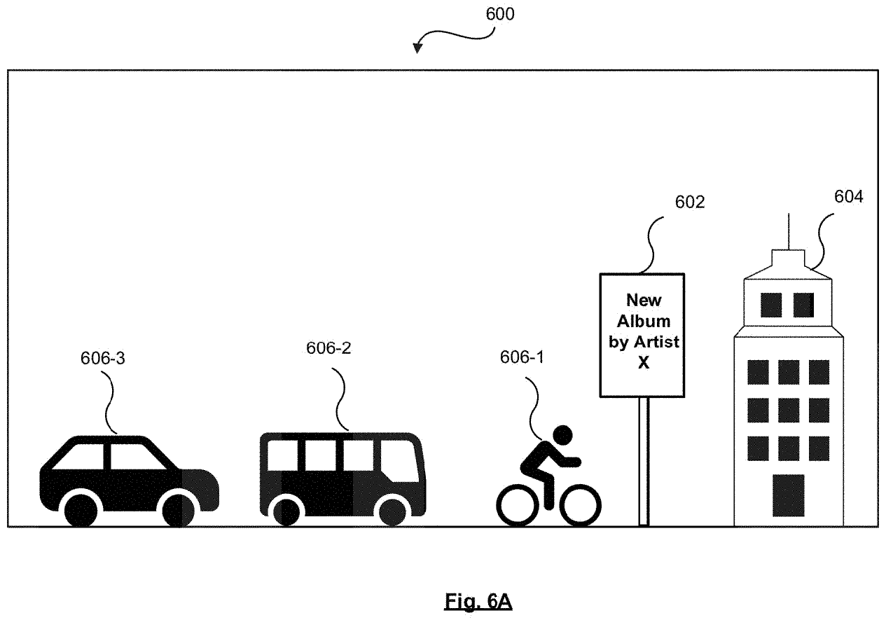

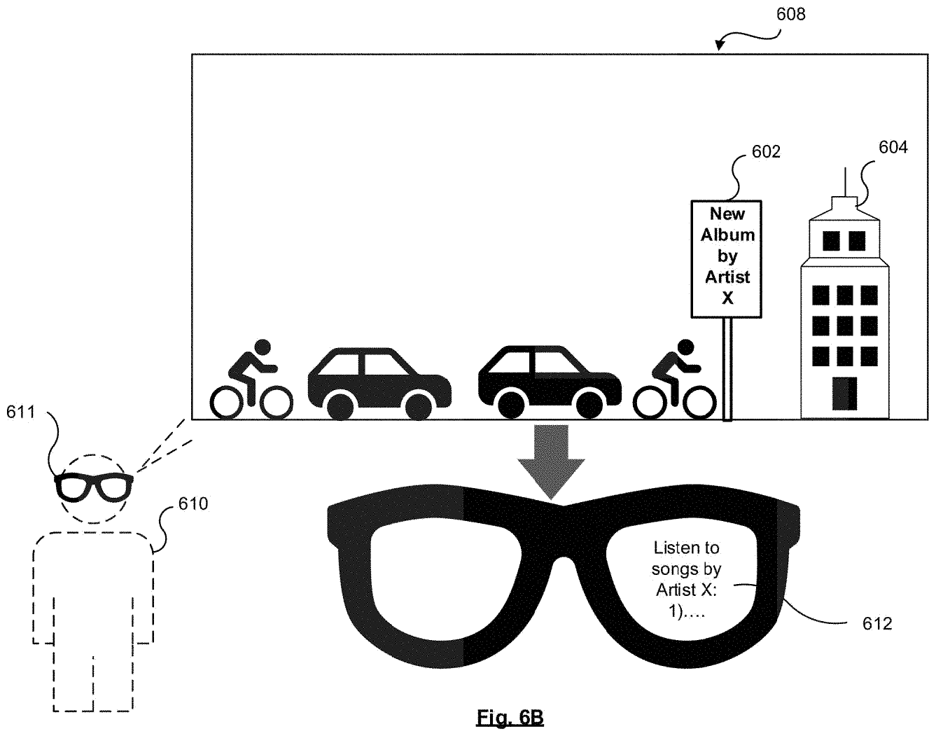

Turning now to FIGS. 6A and 6B, example implementations of methods disclosed herein are illustrated. FIG. 6A shows an example implementation of method 100 disclosed herein e.g., generating augmented tag data, associating content data with the augmented tag data, and outputting the augmented tag data in association with the content data. FIG. 6A shows an image 600 that is captured by a camera. For example, the camera may comprise camera 310, 435, or 530. The image 600 may correspond to a scene of a physical environment (e.g., real-live location). In accordance with the method 100 disclosed herein, image data corresponding to the image 600 is obtained. Furthermore, anchor tag and secondary tag for the image 600 is determined.

As described above, in some examples, the anchor tag may correspond to a visual marker in the image. In this example, a billboard 602 comprising a visual marker (e.g., text “New Album by Artist X”) is designated as the anchor tag. Then, the secondary tag for the image 600 is determined. For example, a static feature of the environment is determined (based on methods described above) and designated as the secondary tag. For example, a building 604 is determined as a static feature, and moving objects such as bike rider 606-1, bus 606-2, and car 606-3 is determined as transient features. The building 604 is designated as the secondary tag. In some examples, location data associated with the image 600 is designated as the secondary tag. In some examples, there is more than one secondary tag. Furthermore, the augmented tag data is generated by associating anchor tag data corresponding to the billboard 602 and secondary tag data corresponding to building 604. Furthermore, content data is associated with the augmented tag data. The content data is associated with the content. The content data is determined based on the anchor tag or the secondary tag. For example, the content is providing an option to a user to listen to songs of new album by Artist X (content associated with the anchor tag). The content data in association with the augmented tag data is output, for example provided to a WHUD. For example, the WHUD is WHUD 500.

FIG. 6B illustrates an example implementation of outputting content associated with the augmented tag. As illustrated in FIG. 6B, a live view (LV) image 608 of a live view in a line of sight of a user 610 wearing a WHUD 611. WHUD 611 is similar to WHUD 500. The LV image 608 comprises the billboard 602 and the building 604 which are designated as the anchor tag and the secondary tag respectively (as described above for FIG. 6A). The billboard 602 is a first feature of the LV image 608, and the building 604 is a second feature of the LV image. Anchor tag data associated the first feature billboard 602 is obtained, and secondary tag data associated with the second feature building 604 is obtained. The anchor tag data and the secondary tag data is compared with augmented tag data, which is associated with a previously captured image 600 of the scene that is captured in the LV image 608 as well. Content data associated with the augmented tag data may also be obtained. Upon detecting a match between the augmented tag data and a combination of the anchor tag data and the secondary tag data, content associated with the content data is output. As described earlier, the content is a display of message 612 on WHUD 611 to user 610 with an option to listen to songs (e.g., sample songs) by Artist X.

As illustrated in FIGS. 6A and 6B, a user 610 wearing the WHUD glances at the billboard (poster-like image) and sample songs are offered up for listening. In this example, the billboard 602, the building 604, and location associated with the image 600, which are designated as the anchor tag and secondary tag(s) provide a mapping of the augmented tag with features of the environment to ensure higher accuracy for content outputting, when a user (e.g., a wearer of the WHUD) sees a scene corresponding to the previously captured image 600 in its live view.

In another example, a user wearing the WHUD (implementing methods and systems disclosed herein) glances at a station map displayed at a train station terminal. The WHUD uses the features of the map (anchor tag) and the station's location (secondary tag) to provide details on the user's next train to work (content associated with the augmented tag data). For example, the details are displayed by the WHUD. In another examples, the details are sent to a user device associated with the user, in the form of a text message, notification, email, or the like.

In another example, a user wearing the WHUD (implementing methods and systems disclosed herein) glances at an image of a contact in a frame on a desk at a workplace, and the WHUD displays the most recent message conversation the user had with a person depicted in the image. The WHUD may have previously recognized a framed image and prompted the user whether they would like to integrate this image with messages from a particular contact, and the user may have selected ‘yes’ and associated the framed image with messages from the contact (associated content data with augmented tag data). The system uses the framed image (anchor tag) of the contact on the desk, the geo location from the workplace (secondary tag), and a snapshot of more static groups of objects in the environment, e.g., the computer monitor, the desk, and the door in the background (secondary tags) to generate the augmented tag (visual tag).

It is contemplated that method 100 and the associated methods described herein is performed by systems 300, 400, WHUD 500, WHUD 611 and the other systems and devices described herein. It is also contemplated that methods 100, 200 and the other methods described herein is performed by systems or devices other than the systems and devices described herein. It is also contemplated that method 200 and the associated methods described herein is performed by systems 300, 400, WHUDs 500 and 611, and the other systems and methods described herein.

In addition, it is contemplated that systems 300, 400, WHUDs 500, 611 and the other systems and devices described herein may have the features and perform the functions described herein in relation to method 100 described herein. In addition, it is contemplated that system 400 and WHUDs 500, 611, and the other systems and devices described herein may have the features and perform the functions described herein in relation to method 200 and the other associated methods described herein. Moreover, systems 300, 400, WHUDs 500, 611 and the other systems and devices described herein may have features and perform functions other than those described herein in relation to methods 100, 200 and the other methods described herein. Further, while some of the examples provided herein are described in the context of augmented reality devices and WHUDs, it is contemplated that the functions and methods described herein is implemented in or by display systems or devices which may not be WHUDs.

Throughout this specification and the appended claims, infinitive verb forms are often used. Examples include, without limitation: “to obtain,” “to generate,” “to associate,” “to output,” and the like. Unless the specific context requires otherwise, such infinitive verb forms are used in an open, inclusive sense, that is as “to, at least, obtain,” to, at least, generate,” “to, at least, associate,” “to, at least, output” and so on.

The above description of illustrated example implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. Moreover, the various example implementations described herein is combined to provide further implementations.

In general, in the following claims, the terms used should not be construed to limit the claims to the specific implementations disclosed in the specification and the claims but should be construed to include all possible implementations along with the full scope of equivalents to which such claims are entitled. Accordingly, the claims are not limited by the disclosure.

1. A method in a computing system, the method comprising:
obtaining image data from a camera, the image data associated with an image;
obtaining anchor tag data associated with an anchor tag associated with the image;
obtaining secondary tag data associated with a secondary tag associated with the image;
generating augmented tag data by associating the anchor tag data with the secondary tag data;
associating content data with the augmented tag data, the content data associated with content; and
outputting the augmented tag data in association with the content data for receipt by a wearable heads-up display (WHUD) to trigger the WHUD to output content based on the content data.

2. The method of claim 1, wherein obtaining the image data from the camera comprises:
capturing the image using a corresponding camera of a corresponding WHUD; and
obtaining the image data associated with the image from the corresponding WHUD.

3. The method of claim 1, wherein obtaining the anchor tag data comprises:
detecting a visual marker in the image; and
designating the visual marker as the anchor tag.

4. The method of claim 1, wherein obtaining the image data comprises:
obtaining a plurality of images of the anchor tag placed within a bounding box;
obtaining another plurality of images of the anchor tag added to an environment; and
associating the anchor tag with features of the environment.

5. The method of claim 1, wherein obtaining the secondary tag data comprises:
determining the secondary tag associated with the image, wherein the secondary tag comprises one or more of: an environment tag, a sensor tag, a location tag, and a contextual tag.

6. The method of claim 5, wherein determining the secondary tag comprises: determining a static feature of an environment in the image, the static feature being associated with the secondary tag.

7. The method of claim 1, wherein obtaining the secondary tag data comprises:
obtaining location data associated with a location associated with the image, the location being associated with the secondary tag of the image.

8. The method of claim 1, further comprising:
determining a change in one or more of: the anchor tag, the secondary tag, and an environment corresponding to the image; and
updating, based on the change, the augmented tag data.

9. The method of claim 1, wherein associating the content data with the augmented tag data comprises:
receiving a selection of the content data, from a plurality of content data, for association with the augmented tag data.

10. The method of claim 1, further comprising:
associating contextual data with the augmented tag data, the contextual data defining a trigger condition for the WHUD to output the content.

11. The method of claim 10, wherein the contextual data is associated with one or more of: a time of day, previous interactions with the WHUD, and a length of time for which a live view is viewable via the WHUD.

12. The method of claim 1, wherein generating the augmented tag data comprises:
determining a quality rating of the augmented tag data by comparing the augmented tag data with a plurality of tag data in a database to determine the quality rating of the augmented tag data.

13. The method of claim 12, wherein comparing the augmented tag data with the plurality of tag data comprises determining a distinctiveness rating of an augmented tag associated with the augmented tag data.

14. The method of claim 12, further comprising at least one of:
outputting the quality rating of the augmented tag data; and
in response to determining that the quality rating of the augmented tag data is below a threshold, adding additional data to the augmented tag data.

15. A system comprising:
a camera to capture an image of a scene; and
a processing engine in communication with the camera, the processing engine to:
obtain image data from the camera, the image data associated with the image;
obtain anchor tag data associated with an anchor tag associated with the image;
obtain secondary tag data associated with a secondary tag associated with the image;
generate augmented tag data by associating the anchor tag data with the secondary tag data;
associate content data with the augmented tag data, the content data associated with content; and
output the augmented tag data in association with the content data, the augmented tag data to be used by a wearable heads-up display (WHUD) to trigger the WHUD to output content based on the content data.

16. The system of claim 15, wherein to obtain the anchor tag data, the processing engine is to:
determine the anchor tag associated with the image.

17. The system of claim 16, wherein to determine the anchor tag, the processing engine is to:
detect a visual marker in the image; and
designate the visual marker as the anchor tag.

18. The system of claim 15, wherein to obtain the image data, the processing engine is to:
obtain a plurality of images of the anchor tag placed within a bounding box;
obtain further image data of a further plurality of images of the anchor tag added to an environment; and
associate the anchor tag with features of the environment.

19. The system of claim 15, wherein the secondary tag comprises one or more of: an environment tag, a sensor tag, a location tag, and a contextual tag.

20. The system of claim 15, wherein to determine the secondary tag, the processing engine is to at least one of:
determine a static feature of an environment in the image, the static feature being associated with the secondary tag of the image; and
obtain location data associated with a location associated with the image, the location associated with the secondary tag of the image.

21. The system of claim 15, wherein to obtain the secondary tag data, the processing engine is to:
obtain inertial measurement unit (IMU) data associated with the image.

22. The system of claim 15, wherein the processing engine is further to:
determine a change in one or more of: the anchor tag, the secondary tag, and an environment corresponding to the image; and
update, based on the change, the augmented tag data.

23. The system of claim 15, wherein to associate the content data with the augmented tag data, the processing engine is to:
obtain a selection of the content data, from a plurality of content data, for association with the augmented tag data.

24. The system of claim 15, wherein the processing engine is further to:
associate contextual data with the augmented tag data, the contextual data defining a trigger condition for the WHUD to output the content.

25. The system of claim 24, wherein the contextual data is associated with one or more of: a time of day, previous interactions with the WHUD, and a length of time for which a live view is viewable via the WHUD.

26. The system of claim 15, wherein:
to generate the augmented tag data, the processing engine is to determine a quality rating of the augmented tag data;
to determine the quality rating, the processing engine is to compare the augmented tag data with a plurality of tag data in a database to determine the quality rating of the augmented tag data; and
to compare the augmented tag data with the plurality of tag data, the processing engine is to determine a distinctiveness rating of an augmented tag associated with the augmented tag data.

27. The system of claim 26, wherein the processing engine is further to at least one of:
output the quality rating of the augmented tag data; and
in response to a determination that the quality rating of the augmented tag data is below a threshold, add additional data to the augmented tag data.

28. A wearable heads-up display (WHUD) comprising:
a camera to capture scenes in a line of sight of the WHUD;
a light engine to generate a display light;
a display optic to receive the display light from the light engine and direct the display light towards an eye of a user of the WHUD to form an image viewable by the user; and
a controller in communication with the camera and the light engine, the controller to:
control the camera to capture a live view (LV) image of a live view in the line of sight of the user of the WHUD;
obtain anchor tag data based on LV image data associated with the LV image, the anchor tag data associated with an anchor tag associated with a first feature of the LV image;
obtain secondary tag data associated with a second feature of the LV image;
obtain augmented tag data comprising corresponding anchor tag data and corresponding secondary tag data, the corresponding anchor tag data associated with a corresponding anchor tag and the corresponding secondary tag data associated with a corresponding secondary tag associated with the corresponding anchor tag;
compare the anchor tag data and the secondary tag data with the corresponding anchor tag data of the augmented tag data and the corresponding secondary tag data of the augmented tag data respectively to detect a match between the augmented tag data and a combination of the anchor tag data and the secondary tag data;
obtain content data associated with the augmented tag data, the content data associated with content; and
in response to detecting the match, output content associated with the content data using the WHUD.
